(19) United States
(12) Patent Application Publication
(10) Pub. No.: US 2023/0363611 A1
(43) Pub. Date: Nov. 16, 2023

(54) SELF-PROPELLED CLEANING MACHINE

(71) Applicant: Hobot Technology Inc., Chupei City (TW)

(72) Inventors: CHI-MOU CHAO, Zhubei City (TW); BO-JHIH LIN, Zhubei City (TW); Tzu-Tse Huang, Zhubei City (TW)

(21) Appl. No.: 18/194,017

(22) Filed: Mar. 31, 2023

(30) Foreign Application Priority Data
May 16, 2022 (CN) 202210527064.1

(51) Int. Cl. A47L 11/40; G05D 1/02; G01S 17/08; G01S 17/931

(52) U.S. Cl. CPC A47L 11/4011; G05D 1/0214; G05D 1/024; G05D 1/0248; G01S 17/08; G01S 17/931; A47L 2201/04; G05D 2201/0203

(57) ABSTRACT

A self-propelled cleaning machine includes a cleaner body, a sensing module disposed at the cleaner body and a control module. The sensing module senses a distance between an object and the sensing module, and includes a transmitter tramsmitting a light signal, and first and second receivers. The first and second receivers receive the light signal respectively to form a first sensing signal and a second sensing signal. The control module controls the cleaning machine according to the two sensing signals. Center lines of a signal range of the transmitter and a view field of the first receiver form a first intersection point. Center lines of the signal range of the transmitter and a view field of the second receiver form a second intersection point. A distance between the second intersection point and the sensing module is greater than a distance between the first intersection point and the sensing module.

### BACKGROUND OF THE INVENTION

### Field of the Invention

The present invention relates to self-propelled cleaning machines and, more particularly, to a self-propelled cleaning machine provided with a sensing module having a plurality of receivers.

### Description of the Prior Art

A self-propelled cleaning machine is a robot in which a body is provided with various sensors and controllers and which is capable of independently completing a predetermined task without manual control during an operation process thereof. Self-propelling cleaning machines, such as sweeping robots, are currently extensively applied in daily lives of people. In some self-propelled cleaning machines, a laser ranging solution is used to measure a distance between a self-propelled device and an obstacle. The principle of such laser ranging solution calculates the distance between the self-propelled device and the obstacle by using a triangulation method.

In the prior art, there are other devices that measure distances using light signals, wherein a distance is determined according to a level of a signal strength received by a light receiver. However, when used to detect an object formed by a material with high reflectivity, such device is likely to obtain higher reflection intensity and hence leads to an incorrect measured distance.

### SUMMARY OF THE INVENTION

It is an objective of an embodiment of the present invention to provide a self-propelled cleaning machine including a sensing module, which is less affected by a material of an object and hence capable of correctly measuring a distance between the object and the sensing module. In one embodiment, preferably, the sensing module includes a transmitter and a plurality of receivers, and controls a movement of the self-propelled cleaning machine according to sensing signals measured by the receivers.

According to an embodiment of the present invention, a self-propelled cleaning machine includes a cleaner body, a sensing module and a control module. The sensing module is disposed at the cleaner body and is configured to sense a distance relationship between an object and the sensing module. The sensing module includes a transmitter, a first receiver and a second receiver. The transmitter is configured to transmit a light signal. The first receiver is disposed at the cleaner body and is configured to receive the light signal that is reflected so as to form a first sensing signal. The second receiver is disposed at the cleaner body and is configured to receive the light signal that is reflected so as to form a second sensing signal. The control module controls the self-propelled cleaning machine according to the first sensing signal and the second sensing signal. A center line of a signal range of the transmitter and a center line of a field of view of the first receiver form a first intersection point, the center line of the signal range of the transmitter and a center line of a field of view of the second receiver form a second intersection point, and a distance between the second intersection point and the sensing module is greater than a distance between the first intersection point and the sensing module.

In one embodiment, the signal range of the transmitter at least partially overlaps the field of view of the first receiver, the signal range of the transmitter at least partially overlaps the field of view of the second receiver, and the field of view of the first receiver at least partially overlaps the field of view of the second receiver.

In one embodiment, the control module further controls a movement of the self-propelled cleaning machine in a way that the distance between the object and the sensing module approximates a distance corresponding thereto when a reading value of the first sensing signal is equal to a reading value of the second sensing signal.

In one embodiment, the sensing module is disposed on one side of the cleaner body; the control module is further configured to control the self-propelled cleaning machine to rotate toward a first rotation direction when it is determined that the first sensing signal and the second sensing signal have a first relationship, and to control the self-propelled cleaning machine to rotate toward a second rotation direction when it is determined that the first sensing signal and the second sensing signal have a second relationship.

In one embodiment, the sensing module is disposed on a right side of the cleaner body; when the reading value of the first sensing signal is set to A and the reading value of the second sensing signal is set to B, the first relationship is a relationship representing A−B>0 and the first rotation direction is a counterclockwise direction, and the second relationship is a relationship representing A−B<0 and the first rotation direction is a clockwise direction. Preferably, in one embodiment, the first relationship is (A−B)/(A+B)>0, and the second relationship is (A−B)/(A+B)<0.

In one embodiment, the sensing module is disposed on a front side of the cleaner body; the first sensing signal and the second sensing signal have a first relationship; when the reading value of the first sensing signal is set to A and the reading value of the second sensing signal is set to B, the control module is further configured to stop a movement in a forward direction of the self-propelled cleaning machine when it is determined that the first relationship is a relationship representing A−B>0.

In one embodiment, the first receiver is located between the transmitter and the second receiver.

In one embodiment, an included angle between a reference plane of the sensing module and the first receiver is smaller than or equal to an included angle between the reference plane of the sensing module and the second receiver.

In one embodiment, a slope defining wall is included between the first receiver and the transmitter, and is configured to render a curve between a reading value and a distance of the first receiver to form a steeper slope within a predetermined distance interval.

In conclusion, in the self-propelled cleaning machine according to an embodiment of the present invention, the sensing module includes a transmitter and a plurality of receivers, controls a movement of the self-propelled cleaning machine according to the sensing signals measured by the receivers, and is less affected by a material of an object and hence capable of correctly measuring a distance between the object and the sensing module. Preferably, in one embodiment, the control module further controls a movement of the self-propelled cleaning machine in a way that the distance between the object and the sensing module approximates a distance corresponding thereto when the reading value of the first sensing signal is equal to the reading value of the second sensing signal, thereby reducing influences of the reflective effect of the material of the object on the reading values of the sensing signals.

### BRIEF DESCRIPTION OF THE DRAWINGS

FIG. 1A is a perspective diagram of a self-propelled cleaning machine according to an embodiment of the present invention.

FIG. 1B is a function block diagram of a self-propelled cleaning machine according to an embodiment of the present invention.

FIG. 2 is a bottom view of a self-propelled cleaning machine according to an embodiment of the present invention.

FIG. 3A is a cross-sectional diagram of a sensing module according to an embodiment of the present invention.

FIG. 3B is a perspective diagram of a sensing module according to an embodiment of the present invention.

FIG. 4A is a schematic diagram of a self-propelled cleaning machine in a state of edge finding according to an embodiment of the present invention.

FIG. 4B is a schematic diagram of a signal range of a transmitter, a field of view of a first receiver and a field of view of a second receiver according to an embodiment of the present invention.

FIG. 4C is a schematic diagram of a center line of the signal range of the transmitter, a center line of the field of view of the first receiver and a center line of the field of view of the second receiver according to an embodiment of the present invention.

FIG. 5 is a schematic diagram of relationship curves of two sensing signals of the first receiver and the second receiver of the sensing module and distances corresponding thereto when the sensing module of an embodiment of the present invention is used to measure a distance of an object, and is a schematic diagram of relationship curves of differences of the sensing signals and the corresponding distances.

FIG. 6A is a schematic diagram of relationship curves of differences of two sensing signals of the first receiver and the second receiver of the sensing module and distances corresponding thereto when the sensing module of an embodiment of the present invention is used to detect a plurality of objects made of different materials.

FIG. 6B is a schematic diagram of a plurality of normalized curves obtained after normalizing the values in the vertical axis of the relationship curves in FIG. 6A.

### DETAILED DESCRIPTION OF THE EMBODIMENTS

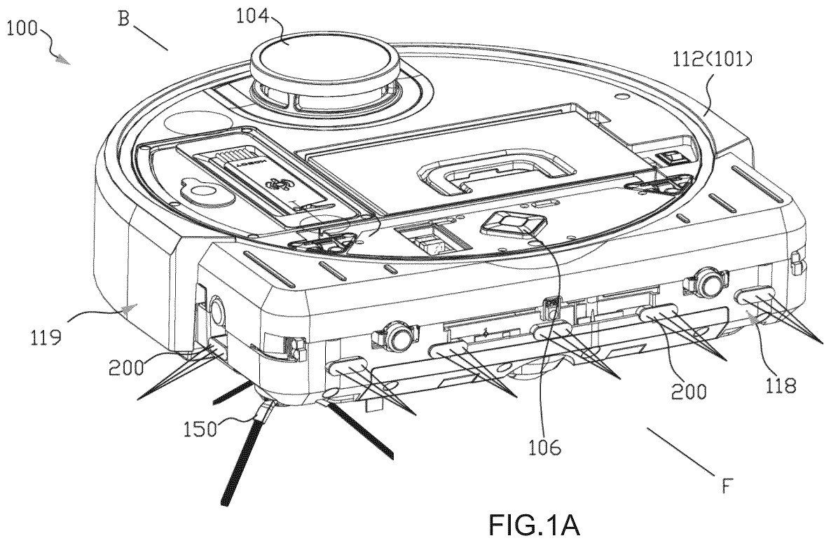

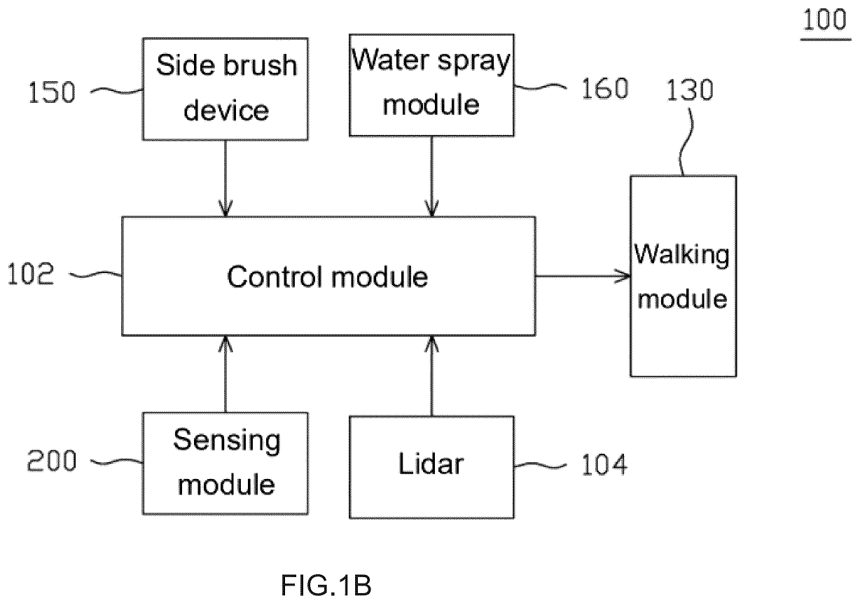

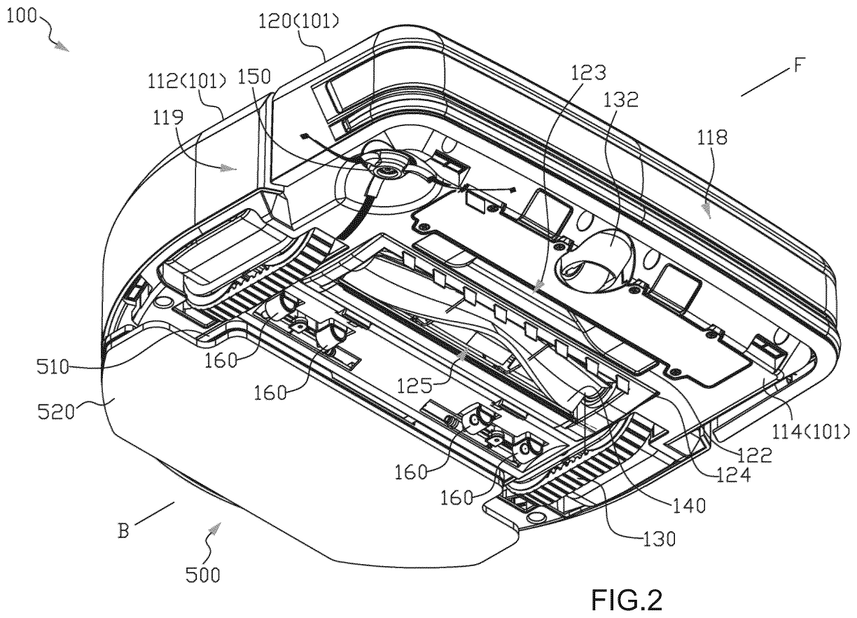

FIG. 1A shows a perspective diagram of a self-propelled cleaning machine according to an embodiment of the present invention. FIG. 1B shows a function block diagram of a self-propelled cleaning machine according to an embodiment of the present invention. FIG. 2 shows a bottom view of a self-propelled cleaning machine 100 according to an embodiment of the present invention. To better understand the operation principles of the self-propelled cleaning machine 100 disclosed by the present invention, detailed description is provided with the accompanying drawings below.

Referring to FIG. 1A and FIG. 1B, the self-propelled cleaning machine 100 includes a cleaner body 101, a sensing module 200 and a control module 102. The cleaner body 101 includes a base 114, a bumper 120 and a casing 112. The base 114 and the casing 112 define an accommodating space for accommodating elements of the self-propelled cleaning machine 100. As shown in FIG. 1A and FIG. 1B, in some embodiments, the self-propelled cleaning machine 100 further includes an operating panel 106 to enable a user to select an operating mode by means of touch control or pressing. The self-propelled cleaning machine 100 can freely move in different directions on a floor to be cleaned. For illustration purposes, the self-propelled cleaning machine 100 herein can move in a forward movement direction F and a backward movement direction B. The bumper 120 faces the forward movement direction F and serves as a front side 118 of the self-propelled cleaning machine 100, and has a flat and straight appearance. In a top view, there are two opposite sides in the self-propelled cleaning machine 100, a side thereof close to a side brush device 150 is a right side 119. The casing 112 faces the backward movement direction B, serves as a back side of the self-propelled cleaning machine 100, and has an arc appearance. However, the shapes of the bumper 120 and the casing 112 are not specifically defined in the present invention.

Referring to FIG. 1A, FIG. 1B and FIG. 2, the self-propelled cleaning machine 100 further includes various elements, for example, a sensing module 200, a cleaning device, a walking module 130, a front wheel 132, the side brush device 150 and a water spray module 160. The control module 102 is configured to control operations of the cleaning device, the side brush device 150 and the water spray module 160. The cleaning device is for cleaning the floor. The foregoing components are attached on the base 114, and extend outward or are exposed from a lower side of the base 114. For illustration purposes, the base 114 herein has an upper side and the lower side, which regard the orientation of the self-propelled cleaning machine 100 positioned in place on the floor to be cleaned as a reference point. The upper side refers to one side back facing the floor to be cleaned, and the lower side refers to another side facing the floor to be cleaned. In this embodiment, the cleaning device can include, for example, a first suction portion 122, a second suction portion 124 and a roller brush device 140. However, the cleaning device is not limited by the present invention, and can include one first suction portion 122, or can include only the second suction portion 124 and the roller brush device 140. In addition, the roller brush device 140 is disposed in a suction port 125 of the second suction portion 124.

The walking module 130 is adjacent to the base 114, located on two opposite sides of the base 114, exposed to the outside from the lower side of the base 114, and located in a center region of the base 114, and comes into contact with the floor to be cleaned when the self-propelled cleaning machine 100 moves on the floor. The walking module 130 can include a pair of walking elements and a driving device. The walking elements can be moving members such as pulleys and rollers. The driving device can be a combination of a motor, a gear and other transmission devices. The walking elements are driven by the driving device, and drive the self-propelled cleaning machine 100 to move forward, backward or turn on the floor to be cleaned. In the embodiment shown, each walking element of the walking module is formed by a pulley, and includes a crawler and two driving wheels that drive the crawler. The front wheel 132 is located in a front region of the self-propelled cleaning machine 100, and is closer to the front side of the self-propelled cleaning machine 100 than the walking module 130. In some embodiments, the front wheel 132 serves as an auxiliary wheel of the walking module 130, assists in maintaining movement balance when the walking module 130 drives the self-propelled cleaning machine 100 to move, and thus is not necessarily provided with an ability of driving the self-propelled cleaning machine 100.

In one embodiment, referring to FIG. 2, the first suction portion 122, the second suction portion 124, the water spray module 160 and a wiping module 500 are, from front to back, sequentially arranged from the front side of the self-propelled cleaning machine 100. The first suction portion 122 and the second suction portion 124 are located in the front half of the base 114, and the water spray module 160 and the wiping module 500 are located in the back half of the base 114. In one embodiment, the wiping module 500 includes a cleaning cloth seat 510, which is arranged on the lower side of the base 114 and has a flat surface parallel to the floor to be cleaned. In one embodiment, one side of the cleaning cloth seat 510 that faces the floor to be cleaned is for attaching or adhering a cleaning cloth 520, so as to clean the floor along a movement direction F of the self-propelled cleaning machine 100. The cleaning cloth seat 510 may be provided with an attaching member, such as a hook and loop fastener, so as to detachably adhere the cleaning cloth 520 to the cleaning cloth seat 510.

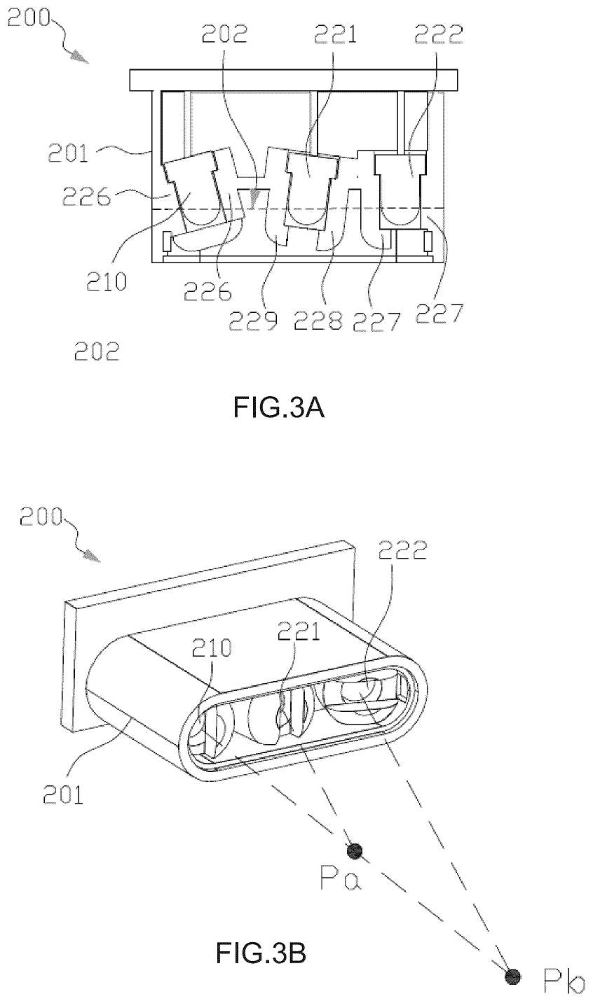

FIG. 3A shows a cross-sectional diagram of a sensing module according to an embodiment of the present invention. FIG. 3B shows a perspective diagram of a sensing module according to an embodiment of the present invention. As shown in FIG. 3A and FIG. 3B, in one embodiment, the sensing module 200 is disposed at the cleaner body 101 and is configured to sense a distance relationship between an object and the sensing module 200. The sensing module 200 includes a shell 201, a transmitter 210, a first receiver 221 and a second receiver 222. The transmitter 210 is configured to transmit a light signal. The first receiver 221 is disposed at the cleaner body 101, and is configured to receive the light signal that is reflected so as to form a first sensing signal. The second receiver 222 is disposed at the cleaner body 101, and is configured to receive the light signal that is reflected so as to form a second sensing signal. The control module 102 controls the self-propelled cleaning machine 100 according to the first sensing signal and the second sensing signal.

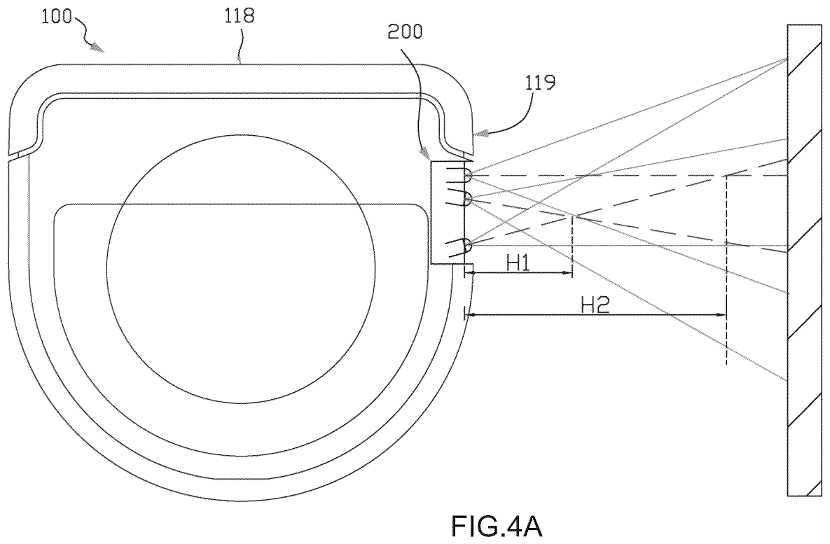

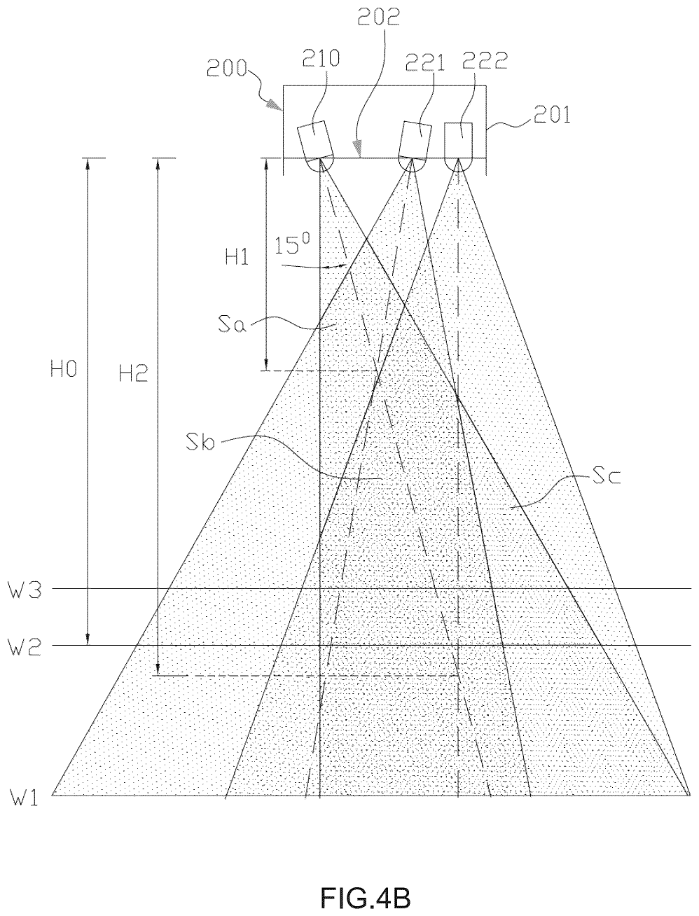

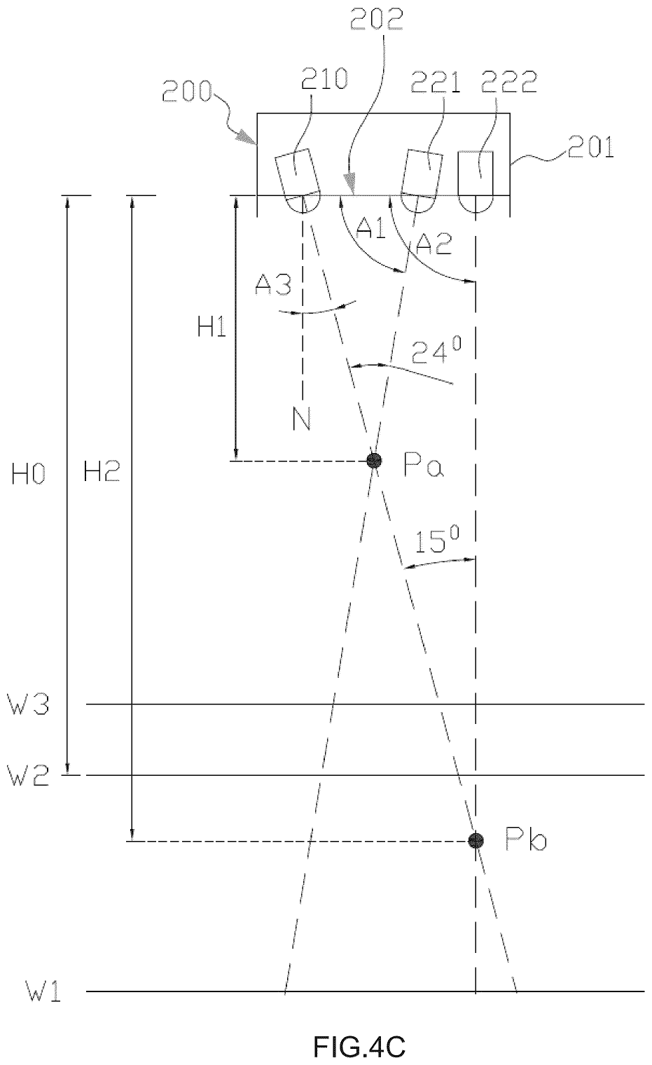

FIG. 4A shows a schematic diagram of a self-propelled cleaning machine in a state of edge finding according to an embodiment of the present invention. FIG. 4B shows a schematic diagram of a signal range of a transmitter, a field of view of a first receiver and a field of view of a second receiver according to an embodiment of the present invention. FIG. 4C shows a schematic diagram of a center line of the signal range of the transmitter, a center line of the field of view of the first receiver and a center line of the field of view of the second receiver according to an embodiment of the present invention. As shown in FIG. 4A, FIG. 4B and FIG. 4C, a center line of a signal range of the transmitter 210 and a center line of a field of view of the first receiver 221 form a first intersection point Pa, the center line of the signal range of the transmitter 210 and a center line of a field of view of the second receiver 222 form a second intersection point Pb, and a distance between the second intersection point Pb and the sensing module 200 is greater than a distance between the first intersection point Pa and the sensing module 200.

In one embodiment, the signal range of the transmitter 210 at least partially overlaps the field of view of the first receiver 221, the signal range of the transmitter 210 at least partially overlaps the field of view of the second receiver 222, and the field of view of the first receiver 221 at least partially overlaps the field of view of the second receiver 222. More specifically, as shown in FIG. 4B, an overlapping region between the signal range of the transmitter 210 and the field of view of the first receiver 221 includes a region Sa and a region Sb, and an overlapping region between the signal range of the transmitter 210 and the field of view of the second receiver 222 includes a region Sc and a region Sb. The region Sa is a region in which only the signal range of the transmitter 210 and the field of view of the first receiver 221 overlap. The region Sb is, with an object W1, W2 or W3 as a boundary, a region in which all three of the signal range of the transmitter 210, the field of view of the first receiver 221 and the field of view of the second receiver 222 overlap. The region Sc is, with the object W1, W2 or W3 as a boundary, a region in which only the signal range of the transmitter 210 and the field of view of the second receiver 222 overlap.

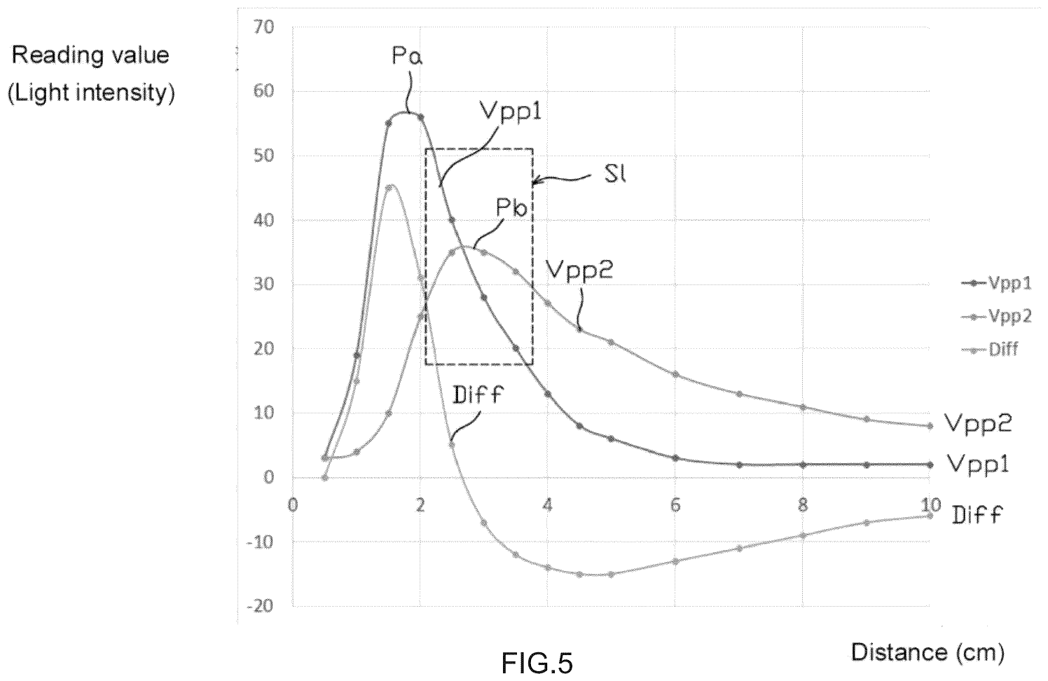

FIG. 5 shows a schematic diagram of relationship curves of reading values of two sensing signals of the first receiver and the second receiver of the sensing module and distances corresponding thereto when the sensing module of an embodiment of the present invention is used to measure a distance of an object, and shows a schematic diagram of relationship curves of differences of the sensing signals and the corresponding distances. As shown in FIG. 5, a relationship curve Vpp1 is a curve indicating the intensity (vertical axis) of a light signal sensed by the first receiver 221 of the sensing module 200, and the distance (horizontal axis) of the self-propelled cleaning machine 100 relative to an object. A relationship curve Vpp2 is a curve indicating the intensity (vertical axis) of a light signal sensed by the second receiver 222 of the sensing module 200, and the distance (horizontal axis) of the self-propelled cleaning machine 100 relative to an object. A curve Diff is a curve obtained by subtracting the relationship curve Vpp2 from the relationship curve Vpp1.

Referring to FIG. 4C and FIG. 5, a peak value of the relationship curve Vpp1 is substantially located at the position of the first intersection point Pa, and a peak value of the relationship curve Vpp2 is substantially located at a position of the second intersection point Pb. An intersection point of the relationship curve Vpp1 and the relationship curve Vpp2 is theoretically a position at which the intensities of light signals sensed by the first receiver 221 and the second receiver 222 are substantially equal. At this point in time, the object sensed by the self-propelled cleaning machine 100 is the object W2 in FIG. 4B and FIG. 4C, and the distance between the self-propelled cleaning machine 100 and the object W2 is H0. That is, this distance is a corresponding distance (hereinafter referred to as a design distance) when a reading value of the first sensing signal is equal to a reading value of the second sensing signal, and is approximately at a position at 2.5 cm in FIG. 5. The design distance may be adjusted according to requirements. For example, the value of the design distance may be adjusted by means of adjusting values of angles of the transmitter 210, the first receiver 221 and the second receiver 222, or by means of adjusting values of the signal range of the transmitter 210, and the fields of view of the first receiver 221 and the second receiver 222. Moreover, in one embodiment, when the object W2 is regarded as the boundary, the area of the region Sa is substantially equal to the area of the region Sb.

In one embodiment, the control module 102 further controls the movement of the self-propelled cleaning machine 100 in a way that the distance between the object and the sensing module approximates the distance H0 corresponding thereto when the reading value of the first sensing signal is equal to the reading value of the second sensing signal. More specifically, when the control module 102 detects that the reading value of the first sensing signal is greater than the reading value of the second sensing signal, for example, when the control module 102 senses the object W3, the control module 102 controls the self-propelled cleaning machine 100 to move in a direction close to the distance H0 corresponding thereto when the reading value of the first sensing signal is equal to the reading value of the second sensing signal. When the control module 102 detects that the reading value of the first sensing signal is smaller than the reading value of the second sensing signal, for example, when the control module 102 senses the object W1, the control module 102 controls the self-propelled cleaning machine 100 to move in a direction close to the distance H0 corresponding thereto when the reading value of the first sensing signal is equal to the reading value of the second sensing signal.

In one embodiment, the sensing module 200 is disposed on one side of the cleaner body 101; the control module 200 is further configured to control the self-propelled cleaning machine 100 to rotate toward a first rotation direction when it is determined that the first sensing signal and the second sensing signal have a first relationship, and to control the self-propelled cleaning machine 100 to rotate toward a second rotation direction when it is determined that the first sensing signal and the second sensing signal have a second relationship. More specifically, referring to FIG. 4A, in one embodiment, the sensing module 200 is disposed on a right side of the cleaner body 101. Moreover, when the reading value of the first sensing signal is set to A and the reading value of the second sensing signal is set to B, a function of a difference between the first sensing signal and the second sensing signal is as follows:

F(A, B)=A−B (1)

At this point in time, the first relationship is a relationship representing A−B>0, and the second relationship is a relationship representing A−B<0. Referring to FIG. 4A, when the sensing module 200 senses A−B>0, the self-propelled cleaning machine 100 is controlled to rotate in the counterclockwise direction by a predetermined angle; when the sensing module 200 senses A−B<0, the self-propelled cleaning machine 100 is controlled to rotate in the clockwise direction by a predetermined angle. With the above control method, the distance between the self-propelled cleaning machine 100 and the object is kept at the distance H0 as much as possible. When the object is a wall, the self-propelled cleaning machine 100 can be controlled to move along the wall in a way of maintaining the distance H0 between the self-propelled cleaning machine 100 and the wall.

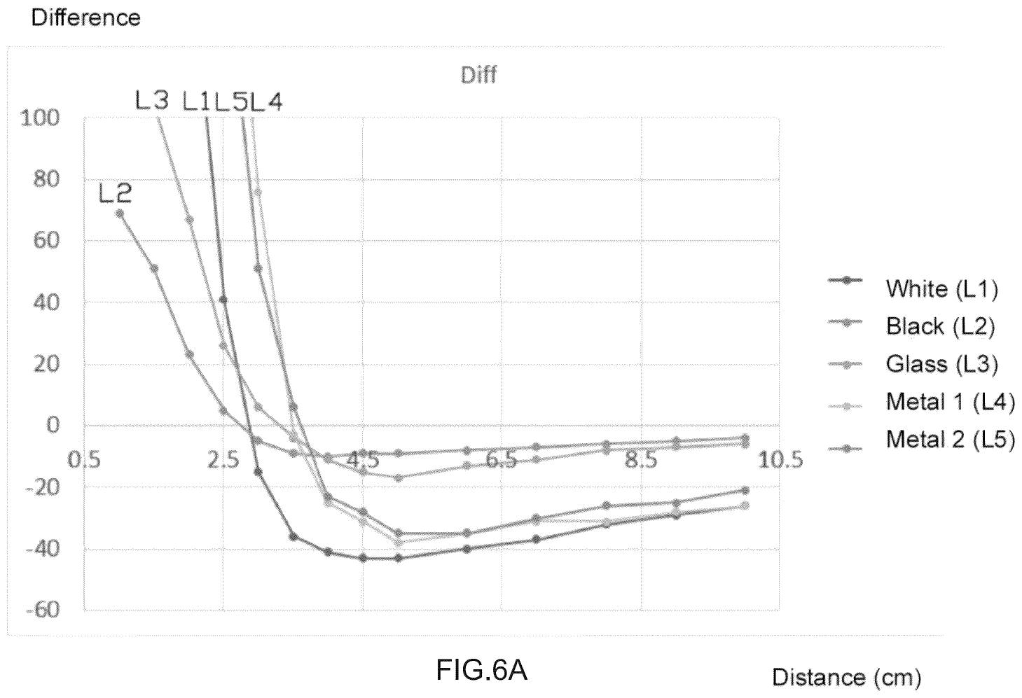

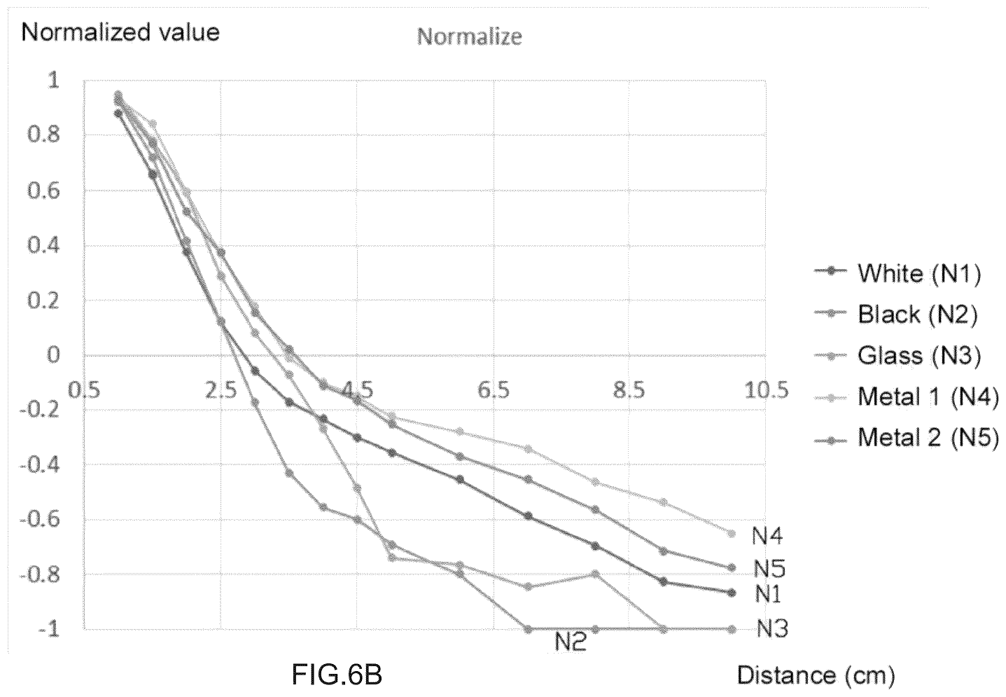

FIG. 6A shows a schematic diagram of relationship curves of differences of two sensing signals of the first receiver and the second receiver of the sensing module and distances corresponding thereto when the sensing module of an embodiment of the present invention is used to detect a plurality of objects made of different materials. The sensing module in FIG. 6A differs from the sensing module in FIG. 5 in respect of angles of the transmitter 210, the first receiver 221 and the second receiver 222. As shown in FIG. 6A, when the object is white, black, glass, a metal 1 and a metal 2, the curves of differences between the reading value of the first sensing signal and the reading value of the second sensing signal detected by the sensing module 200 are respectively a curve L1, a curve L2, a curve L3, a curve L4 and a curve L5. The positions of the point of these curves L1 to L5 that the difference on the vertical axis is 0 are approximately between 2.77 cm and 3.61 cm. It is accordingly known that, for these different materials detected by the sensing module 200, a difference between a maximum value and a minimum value of the plurality of distances H0 when the reading value of the first sensing signal is equal to the reading value of the second sensing signal merely approximates (3.61−2.77=)0.84 cm. Thus, the sensing accuracy of the sensing module is enhanced.

FIG. 6B shows a schematic diagram of a plurality of normalized curves obtained after normalizing the values in the vertical axis of the relationship curves in FIG. 6A. In one embodiment, normalization may be performed by using an equation (2) below for the vertical axis (the reading values of the sensing signals) of the curves L1 to L5 in FIG. 6A to obtain normalized curves N1 to N5 in FIG. 6B. As shown in FIG. 6B, when the reading values of the normalized curves N1 to N5 in the vertical axis are greater than 0, differences of the normalized curves N1 to N5 in the horizontal axis (distance) are smaller; when the reading values of the normalized curves N1 to N5 in the vertical axis are smaller than 0, the differences of the normalized curves N1 to N5 in the horizontal axis (distance) are larger. The reason for the above is that, when the reading value in the vertical axis after the normalization is greater than 0, these normalized curves N1 to N5 are very close, and can thus be used to determine the distance between the self-propelled cleaning machine 100 and the object. That is, using the normalized curves, distance measurement can be implemented within a short distance. For example, as shown in FIG. 6B, when the sensing module 200 detects that the normalized values are respectively, 0.4, 0.6 and 0.8, it is determined that the distances between the self-propelled cleaning machine 100 and the object are respectively 2.5 cm, 1.39 cm and 0.83 cm. In this embodiment, the distance measured becomes more accurate as the distance between the self-propelled cleaning machine 100 and the object W2 gets shorter.

$$F ( A , B ) = \frac{A - B}{A + B} \qquad ( 2 )$$

Preferably, in one embodiment, the first relationship is (A−B)/(A+B)>0, and the second relationship is (A−B)/(A+B)<0.

The equation for the normalization is not specifically defined in the present invention. In one embodiment, equation (3) below may also be used for the normalization.

$$F ( A , B ) = 1 - \frac{B}{A} \qquad ( 3 )$$

At this point in time, the first relationship may be (A−B)/A>0, and the second relationship may be (A−B)/A<0.

In one embodiment, the sensing module 200 is disposed on a front side of the cleaner body 101; the first sensing signal and the second sensing signal have a first relationship; when the reading value of the first sensing signal is set to A and the reading value of the second sensing signal is set to B, the control module 102 is further configured to stop a movement in a forward direction of the self-propelled cleaning machine 100 when it is determined that the first relationship is a relationship representing A−B>0, which indicates that the distance between the self-propelled cleaning machine 100 and the object is already smaller than the distance H0 (the distance H0 is the distance corresponding thereto when the reading value of the first sensing signal is equal to the reading value of the second sensing signal). Thus, the self-propelled cleaning machine 100 is prevented from colliding with the object.

As shown in FIG. 1A and FIG. 1B, in one embodiment, the self-propelled cleaning machine 100 may further include a light detection and ranging (lidar) 104, which is disposed on a top surface of the cleaner body 101 of the self-propelled cleaning machine 100 and protrudes from the top surface. A plurality of sensing modules 200 are disposed on a front side of the cleaner body 101 and are located below the lidar 104. According to this embodiment, the self-propelled cleaning machine 100 can primarily use the lidar 104 to determine a distance and measure a map of the environment, and use the sensing modules 200 to sense an object or an obstacle located below the lidar 104.

In one embodiment, as shown in FIG. 3A, the first receiver 221 is located between the transmitter 210 and the second receiver 222. More specifically, the transmitter 210 is disposed on a first side (leftmost side) of the sensing module 200, the second receiver 222 is disposed on a second side (rightmost side) opposite to the first side of the sensing module 200, and the first receiver 221 is located between the transmitter 210 and the second receiver 222. The arrangement of the above design occupies minimal space and reduces the volume of the sensing module 200.

In one embodiment, preferably, an included angle between the center line of the transmitter 210 and the center line of the first receiver 221 is greater than an included angle of the center line of the transmitter 210 and the center line of the second transceiver 222. As shown in FIG. 4C, the included angle between the center line of the signal range of the transmitter 210 and the center line of the field of view of the first receiver 221 is approximately 24°, and the included angle between the center line of the signal range of the transmitter 210 and the center line of the field of view of the second receiver 222 is approximately 15°. These angles may be determined with consideration of different products and the width of the sensing module 200. If the size of the sensing module 200 is larger, in one embodiment, the included angle between the center line of the transmitter 210 and the center line of the second receiver 222 may also be greater than the included angle between the center line of the transmitter 210 and the center line of the first receiver 221.

In one embodiment, the sensing module 200 includes a reference plane 202, and the transmitter 210, the first receiver 221 and the second receiver 222 are all disposed according to the reference plane 202, such that the reference plane 202 is configured not to block light emitted by the transmitter 210 and the light can be received by the first receiver 221 and the second receiver 222 once the light is emitted from the transmitter 210. Preferably, an included angle A1 between the reference plane 202 of the sensing module 200 and the center line of the first receiver 221 is smaller than or equal to an included angle A2 between the reference plane 202 of the sensing module 200 and the center line of the second receiver 222. For illustration purposes, the included angle herein refers to an angle less than or equal to 90°, as shown in FIG. 4C. With the above arrangement, the first receiver 221 is enabled to receive more light at a closer distance, for example, 2.5 cm, and the second receiver 222 is enabled to receive more light at a farther distance, for example, 4.0 cm.

In one embodiment, a distance H2 between the second intersection point Pb and the reference plane 202 of the sensing module 200 is greater than a distance H1 between the first intersection point Pa and the reference plane 202 of the sensing module 200. With the above design, the distance H0 corresponding thereto when the reading value of the first sensing signal is equal to the reading value of the second sensing signal can be kept between the distance H1 and the distance H2. In a preferable situation, the distance H1 is between 1.0 cm and 3.0 cm, and the distance H2 is greater than 3.5 cm. More preferably, the distance H1 is between 2.0 cm and 3.0 cm, and the distance H2 is greater than 4.0 cm. When the distance H2 is infinite, it means that the transmitter 210 is parallel to the second receiver 222. Moreover, in one embodiment, the distance H2 may be between 3.5 cm and 5.0 cm, and preferably the distance H2 is between 4.0 cm and 5.0 cm, and such design yields a better effect than the situation when the distance H2 is infinite. To achieve the above ranges of the distance H1 and the distance H2, only the respective angles of the first receiver 221 and the second receiver 222 need to be changed. In other words, the angles of the first receiver 221 and the second receiver 222 are configured to angles achieving the above ranges of the distance H1 and the distance H2.

In one embodiment, as shown in FIG. 4C, in order to enable most of the light emitted by the transmitter 210 to reflect to locations where the first receiver 221 and the second receiver 222 can receive the light, preferably, an angle A3 between the center line of the transmitter 210 and a normal line N of the reference plane 202 is greater than 0° and is preferably greater than 5°. More preferably, in order to enable most of the light emitted by the transmitter 210 to reflect toward the first receiver 221 and the second receiver 222, the angle A3 between the center line of the transmitter 210 and the normal line N of the reference plane 202 is greater than one-half of a transmission range of the transmitter 210, for example, greater than 15°. As shown in FIG. 4B, in this embodiment, the transmission range of the transmitter 210 is approximately 30°, that is, the angle between the center line of the transmitter 210 and the left boundary of the transmission range thereof is one-half of 30°, that is, approximately 15°. Thus, the angle A3 between the center line of the transmitter 210 and the normal line N of the reference plane 202 is configured to be greater than or equal to 15°. With such design, most reflected light can be reflected to the side provided with the first receiver 221 and the second receiver 222.

As shown in FIG. 3A and FIG. 5, in one embodiment, a slope defining wall 229 is provided between the first receiver 221 and the transmitter 210, and is configured to render the relationship curve Vpp1 between the reading value and the distance of the first receiver 221 to form a steeper slope within a predetermined distance interval S1 shown in FIG. 5. In the lack of the special design of the slope defining wall 229, the relationship curve Vpp1, similar to the relationship curve Vpp2, gradually descends after a peak value. In order to emphasize the distinguishability of the curve Diff, the inclining angle of the slope defining wall 229 can be set to have the relationship curve Vpp1 to form a greater slope within the predetermined distance interval S1.

In one embodiment, the transmitter 210 is located between two transmission field defining walls 226, so that the signal range of the transmitter 210 is within a predetermined range. The second receiver 222 is located between two field of view defining walls 227, so that the field of view of the second receiver 222 is within a predetermined range. The first receiver 221 is located between the slope defining wall 229 and a field of view defining wall 228, so that the field of view of the first receiver 221 is within a predetermined range and a greater slope is formed within the predetermined distance interval S1.

According to an embodiment of the present invention, the control module 102 controls the movement of the self-propelled cleaning machine 100 in a way that the distance between the object and the sensing module 200 approximates the distance corresponding thereto when the reading value of the first sensing signal is equal to the reading value of the second sensing signal. Since both of the reading value of the first sensing signal and the reading value of the second sensing signal are light signal intensity values of light signals transmitted by the transmitter 210 and reflected by a reflecting plane, using the difference (for example, A−B=0) between the two or a ratio (for example, A/B=1) between the two to determine a distance can reduce an error in the measured distance caused by material discrepancies. Compared to the prior art, the distance is determined by light signal intensities only, and therefore a more accurate distance can be measured and obtained.

What is claimed is:

1. A self-propelled cleaning machine, comprising:
a cleaner body;
a sensing module, disposed at the cleaner body and configured to sense a distance relationship between an object and the sensing module, the sensing module comprising:
a transmitter configured to transmit a light signal,
a first receiver, disposed at the cleaner body and configured to receive the light signal that is reflected so as to form a first sensing signal, and
a second receiver, disposed at the cleaner body and configured to receive the light signal that is reflected so as to form a second sensing signal; and
a control module, controlling the self-propelled cleaning machine according to the first sensing signal and the second sensing signal,
wherein,
a center line of a signal range of the transmitter and a center line of a field of view of the first receiver form a first intersection point,
the center line of the signal range of the transmitter and a center line of a field of view of the second receiver form a second intersection point, and
a distance between the second intersection point and the sensing module is greater than a distance between the first intersection point and the sensing module.

2. The self-propelled cleaning machine according to claim 1, wherein
the signal range of the transmitter at least partially overlaps the field of view of the first receiver,
the signal range of the transmitter at least partially overlaps the field of view of the second receiver, and
the field of view of the first receiver at least partially overlaps the field of view of the second receiver.

3. The self-propelled cleaning machine according to claim 1, wherein the control module further controls a movement of the self-propelled cleaning machine in a way that the distance between the object and the sensing module approximates the distance at which a reading value of the first sensing signal is equal to a reading value of the second sensing signal.

4. The self-propelled cleaning machine according to claim 1, wherein the sensing module is disposed on one side of the cleaner body, and the control module is further configured to control the self-propelled cleaning machine to rotate toward a first rotation direction when it is determined that the first sensing signal and the second sensing signal have a first relationship, and to control the self-propelled cleaning machine to rotate toward a second rotation direction when it is determined that the first sensing signal and the second sensing signal have a second relationship.

5. The self-propelled cleaning machine according to claim 4, wherein the sensing module is disposed on a right side of the cleaner body, and when the reading value of the first sensing signal is set to A and the reading value of the second sensing signal is set to B, the first relationship is a relationship representing A−B>0 and the first rotation direction is a counterclockwise direction, and the second relationship is a relationship representing A−B<0 and the first rotation direction is a clockwise direction.

6. The self-propelled cleaning machine according to claim 5, wherein the first relationship is (A−B)/(A+B)>0, and the second relationship is (A−B)/(A+B)<0.

7. The self-propelled cleaning machine according to claim 1, wherein the sensing module is disposed on a front side of the cleaner body, the first sensing signal and the second sensing signal have a first relationship, and when the reading value of the first sensing signal is set to A and the reading value of the second sensing signal is set to B, the control module is further configured to stop a movement in a forward direction of the self-propelled cleaning machine when it is determined that the first relationship is a relationship representing A−B>0.

8. The self-propelled cleaning machine according to claim 1, wherein the first receiver is located between the transmitter and the second receiver.

9. The self-propelled cleaning machine according to claim 8, wherein an included angle between a reference plane of the sensing module and the first receiver is smaller than or equal to an included angle between the reference plane of the sensing module and the second receiver.

10. The self-propelled cleaning machine according to claim 8, comprising:
a slope defining wall between the first receiver and the transmitter, the slope defining wall being configured in a way that a curve between a reading value of the first receiver and a distance corresponding to the reading value of the first receiver forms a greater slope within a predetermined distance interval.

11. The self-propelled cleaning machine according to claim 1, wherein the control module further determines the value of the distance between the object and the sensing module according to the first sensing signal and the second sensing signal.

12. The self-propelled cleaning machine according to claim 1, wherein the control module further determines the value of the distance between the object and the sensing module according to a difference or a ratio between the first sensing signal and the second sensing signal.

13. The self-propelled cleaning machine according to claim 12, wherein the control module further normalizes a difference between the first sensing signal and the second sensing signal, and determines the value of the distance between the object and the sensing module according to the normalized difference between the first sensing signal and the second sensing signal.
